(19) United States
(12) Patent Application Publication
(10) Pub. No.: US 2008/0028218 A1
(43) Pub. Date: Jan. 31, 2008

(54) Software & license and physical/virtual machine asset management library application with check-out/check-in, front-end asset load, tracking, reporting, reconciliation and associated methods

(76) Inventor: Jonathon Burton Simon, Round Rock, TX (US)

Correspondence Address: JONATHON B. SIMON, 705 DAVID CURRY, ROUND ROCK, TX, 78664, US

(21) Appl. No.: 11/811,830

(22) Filed: Jun. 12, 2007

Related U.S. Application Data
(60) Provisional application No. 60/812,944, filed on Jun. 13, 2006.

(51) Int. Cl. H04L 9/00

(52) U.S. Cl. 713/170

(57) ABSTRACT

A method for providing software/license and physical/virtual machine management is disclosed for a specialized asset management system. The specialized asset management system aggregates physical and online software assets and their corresponding license(s), as well as physical and virtual machines into a unified library system wherein assets can be managed, used, reserved, tracked, reconciled, and reported on using a library check-out and check-in paradigm.

This utility patent application represents the full utility patent of the “small entity” provisional application Ser. No. 60/812,944 entitled “ASSET MANAGEMENT COMPUTER APPLICATION FOR SOFTWARE AND LICENSE ASSETS,” which was filed by USPTO on Jun. 13, 2006.

### TECHNICAL FIELD OF THE INVENTION

This invention relates generally to the field of an asset management computer application for software assets and their corresponding license(s), as well as physical machine assets and/or virtual machine assets. This invention manages software, licenses, physical and virtual machines using a library paradigm, wherein all assets are inventoried into a relational back-end DB and cross-referenced with each other using a unique key of record, thus enabling the check-out and/or check-in of said assets, all the while maintaining firm data integrity and a consistently reconciled library of assets.

### BACKGROUND

Prior asset management systems have focused generically on the management of a what is deemed to be a company's capital assets without regard for what the assets actually are, or for what purpose they are used within a company or organization. Often, these generic capital assets are tightly coupled with finance systems in order to track depreciation and amortization. However, never has there been an asset management system specifically tailored for the management of software assets and their corresponding license(s) using a library check-out/check-in paradigm, nor has there ever been an asset management system specifically tailored for the dynamic check-out and check-in of physical & virtual machines.

In the case of software and license assets, quite often the individual departments within a company independently budget for and purchase their own software and licenses and/or maintain their own software subscriptions with multiple software vendors. Compound this by multiple departments, and eventually, a single company or organization potentially has many islands of disparate software and license resources—most of which are inefficiently managed—if they are managed at all. This results in excessive unused licenses, potentially unnecessary maintenance fees, poor inter-office resource sharing, and license compliance problems, etc. Even if a company or organization has centralized all software and license management operations to one specific department, it is none-the-less still an onerous task to manage an entire company's software and license assets effectively so as to maintain maximum efficiency related to overall license utilization, payment of maintenance fees to software vendors, streamlined inter-office resource sharing, and the avoidance of license compliance problems, which can often times result in lengthy audits culminating in fines.

Similarly, in the case of physical machines and virtual machines, we find that pools of these assets are often allocated to specific projects for finite time periods. During these periods of allocation, company's often loose track of which machines are in use, and by whom, as well as more granular details, such as what OS is running on a particular machine, what network address is in use by a particular machine, what are the logon credentials for a particular machine, what is the project to which the machine is allocated, and who is the point of contact for a particular machine, etc. Just as in the case of software and licenses, these issues are compounded by the fact that individual departments may be the defacto owners of the physical and virtual machines in use in their respective departments. This results in the exact same types of problems as experienced with islands of individually managed software and license assets, namely, excessive unused and/or underused resources, potentially unnecessary maintenance fees, poor inter-office resource sharing, license compliance problems, etc.

Significantly, these prior asset management systems have failed to fully address the inherent efficiency which can result from maintaining software & license assets and physical/virtual machines assets in a fully indexed online library environment with check-out and check-in enforcement for ease of tracking, reporting, and reconciliation.

### SUMMARY OF THE INVENTION

The present invention provides an end-to-end comprehensive computer management system for administering the check-out and check-in of software assets along with their corresponding license(s). Additionally, the present invention provides a comprehensive end-to-end management system for administering the check-out and check-in of physical/virtual machines. Whether the present invention is used exclusively for software/license assets or exclusively for physical/virtual machines, or even a combination of both—the present invention provides full tracking, reporting, and reconciliation of the assets under management, which in turn enables the system administrator to know precisely at any moment the exact state of all assets under management.

In its most basic embodiment, the present invention operates stand-alone and manages internally used software and license(s) and/or physical/virtual machines assets belonging to a single owner. In this context, a single owner could be expanded to mean a single organization/company, consisting of many departments, all of whom have software & license and physical/virtual machine assets that are managed by a centralized instance of the present invention, which is accessed over a non-public network.

A second embodiment enables the present invention to fully manage the internally consumed software and license(s) and/or physical/virtual machines of multiple owners, via the Internet, all the while maintaining a consistently reconciled library of assets for each and every independent owner. In this context, multiple owners could be expanded to mean many organization/companies, each of which has many departments, and all of whom have software & license and physical/virtual machine assets that are managed by a centralized instance of the present invention, which is accessed over the public Internet. The present invention is able to accomplish such complex management of multiple owner assets because of the present invention's unique utilization of common asset metadata maintained in its relational database.

Yet a third embodiment enables the present invention to manage software and license assets that are meant to be resold, or externally consumed. This embodiment of the present invention uses programmatic logic to integrate with 3^{rd} party information systems, such as online CRM vendors. Resell/externally consumed software and licenses inherently have different tracking and compliance implications than do internally used software and licenses, and the present invention is able to fully manage such an implementation. This embodiment, just as the previously described embodiments, is able to manage physical/virtual machines as well.

The foregoing has outlined, in general, certain aspects of the invention and is to serve as an aid to better understanding the more complete detailed description, which is to follow. In reference to such, there is to be a clear understanding that the present invention is not limited to the method or detail of construction, development, fabrication, material, or application of use described herein. Any other variation of fabrication, use, or application should be considered apparent as an alternative embodiment of the present invention.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram of the software & license and physical/virtual machine library system in one of its primary embodiments, namely: standalone or single user, according to the present invention.

FIG. 2 is a block diagram of the software & license and physical/virtual machine library system in another of its primary embodiments, namely: multiple owners, according to the present invention.

### DETAILED DESCRIPTION OF THE INVENTION

This present invention was developed to address the inherent problems surrounding the management of software & license assets, as well as physical/virtual machines, namely, tracking who, what, when, and where a particular software & license or physical/virtual machine is being used, as well as enforcing compliance based on utilization terms.

This present invention is able to manage assets by creating a unique record for each software & license or physical/virtual machine asset and then persist all utilization associated with each asset to a database based on check-out and check-in activity.

With the database Meta Data, this present invention is able to perform sophisticated record-keeping and analytics in such a way so as to track who, what, when, and where a particular software & license or physical/virtual machine asset is being used, as well as enforcing strict compliance based on utilization terms.

In its most basic mode of operation, the present invention operates stand-alone, and manages internally consumed software & license or physical/virtual machine assets belonging to a single owner. A second mode of operation enables the present invention to fully manage the internally consumed software & license or physical/virtual machine assets of multiple owners, via the Internet, all the while maintaining a consistently reconciled library of assets for each and every independent owner. Yet a third mode of operation enables the present invention to manage license assets that are meant to be resold, or externally consumed. Resell/externally consumed licenses inherently have different tracking and compliance implications than internally used licenses.

Under all modes of operation, this present invention has a built-in knowledge-base utility that allows users to add knowledge entries for the software & license or physical/virtual machine assets under management. Furthermore, the present invention has a queuing system, which allows users to add themselves to a wait list in the event the particular software & license or physical/virtual machine asset that they wish to check-out is already checked-out. Once the current owner checks-in the asset, the queued user is notified and is given priority check-out access. Furthermore, the present invention has a sophisticated reporting engine, which empowers the software administrator to have full knowledge of the asset utilization of all assets under management.

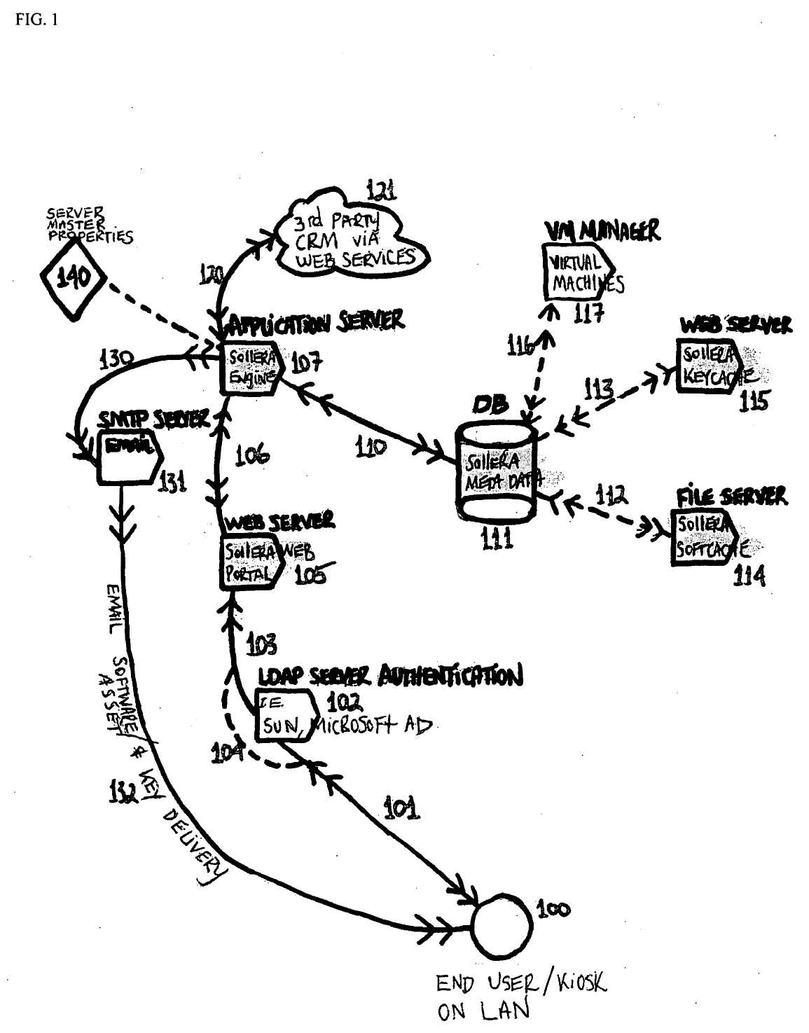

FIG. 1 is a block diagram that illustrates the system(s) and process(es) comprising one embodiment of the present invention. Specifically, the embodiment represented by FIG. 1 is a single owner implementation of the present invention. In this context, a single owner could be expanded to mean a single organization/company, consisting of many departments, all of whom have software & license and physical/virtual machine assets that are managed by a centralized instance of the present invention, which in turn, is accessed over a non-public network.

Referring to FIG. 1, a user logs on to the present invention via a web portal or dedicated kiosk [100] on a LAN (Local Area Network). The logon process involves bi-directional communication [101] to an LDAP authentication source, such as SUN Directory Server or Microsoft Active Directory [102]. Once the user is authenticated via LDAP, the communication flow [103] is directed to the web portal of the present invention [105]. The web portal is the front-end, or access-point, into the present invention from where all functions or processes are accessed; from the web portal, a user can perform ALL user and administrative level functions, such as, but not limited to, searching, checking-out, checking-in, queuing, adding, removing, editing, and categorizing software & license or physical/virtual machine assets. All functions or processes that are invoked by a user or administrator in the web portal are processed in the engine of the present invention [107] via a bi-directional communication flow [106]. Depending on the function or process invoked by the user or administrator from the web portal [105], the engine of the present invention queries [110] the back-end RDBMS [111] and/or also queries [112, 113] the cache repositories [114, 115] for the license key(s) and online software source(s), in the case of functions or processes involving software & license assets. Similarly, in the case of functions involving physical/virtual machine assets, the engine queries [110] the back-end RDBMS [111] and/or also queries [116] the VM (Virtual Machine) manager [117].

After the engine has performed the necessary back-end queries and requisite processing, the output of all processing is returned to the user or administrator in the form of a web page on the web portal. Some processes generate one or more emails all of which are sourced by the engine of the present invention, but delivered via the SMTP server [131] and a uni-directional communication flow [132] to the end user. Processes that generate one or more emails include, but are not limited to, check-out, check-in, queuing, and administrative asset reconciliation. It is important to note that once a user or administrator has been authenticated to the present invention, ALL subsequent interaction with the present invention follows a post-authentication communication pathway [103-104-101], which effectively bypasses the authentication routine for the duration of the session. However, once a user or administrator terminates a session by logging off from the present invention, re-authentication is enforced [101-102-103].

The present invention is able to manage software & license assets that are meant to be resold or externally consumed, hereby referred to as Resell Licenses. Resell Licenses involve special processes, such as, but not limited to, quarterly royalty reporting, which are often tightly coupled to Sales pipelines, maintenance payments, and 3^{rd} party ISV OEM agreements. The present invention is able to integrate with other software parties [120] via web services [121] for specific processes involving Resell Licenses.

All available functions and processes in the present invention are tightly coupled to the master server properties file [140]. This global properties file maintains key parameters and settings, which directly affect the runtime of the present invention. Global properties contained in this file are read at startup and during the normal operation of the present invention.

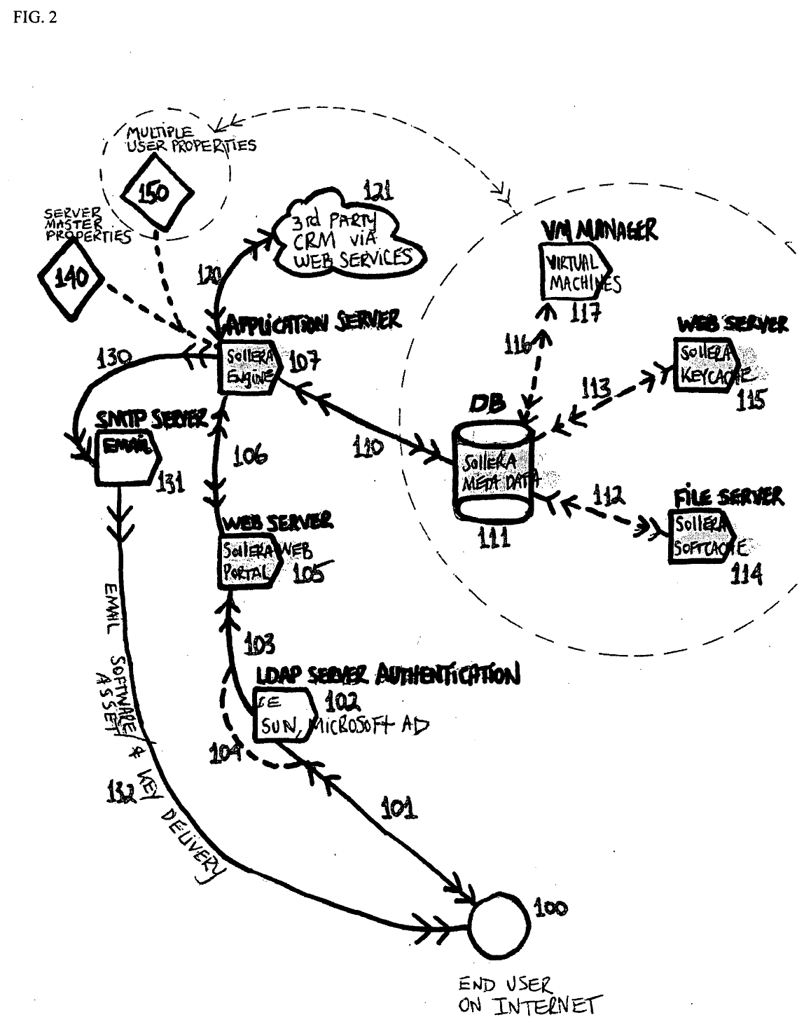

FIG. 2 is a block diagram that illustrates the system(s) and process(es) comprising a different embodiment of the present invention. Specifically, the embodiment represented by FIG. 2 is a multiple owner implementation of the present invention. In this context, multiple owners could be expanded to mean many organization/companies, each of which has many departments, and all of whom have software & license and physical/virtual machine assets that are managed by a centralized instance of the present invention, which in turn, is accessed over the public Internet.

Referring to FIG. 2, a user logs on to the present invention via a web portal or dedicated kiosk [100] via the Internet. The logon process involves bi-directional communication [101] to an LDAP authentication source, such as SUN Directory Server or Microsoft Active Directory [102]. Once the user is authenticated via LDAP, the communication flow [103] is directed to the web portal of the present invention [105]. The web portal is the front-end, or access-point, into the present invention from where all functions or processes are accessed; from the web portal, a user can perform ALL user and administrative level functions, such as, but not limited to, searching, checking-out, checking-in, queuing, adding, removing, editing, and categorizing software & license or physical/virtual machine assets. All functions or processes that are invoked by a user or administrator in the web portal are processed in the engine of the present invention [107] via a bi-directional communication flow [106]. Depending on the function or process invoked by the user or administrator from the web portal [105], the engine of the present invention queries [110] the back-end RDBMS [111] and/or also queries [112, 113] the cache repositories [114, 115] for the license key(s) and online software source(s), in the case of functions or processes involving software & license assets. Similarly, in the case of functions involving physical/virtual machine assets, the engine queries [110] the back-end RDBMS [111] and/or also queries [116] the VM (Virtual Machine) manager [117].

After the engine has performed the necessary back-end queries and requisite processing, the output of all processing is returned to the user or administrator in the form of a web page on the web portal. Some processes generate one or more emails all of which are sourced by the engine of the present invention, but delivered via the SMTP server [131] and a uni-directional communication flow [132] to the end user. Processes that generate one or more emails include, but are not limited to, check-out, check-in, queuing, and administrative asset reconciliation. It is important to note that once a user or administrator has been authenticated to the present invention, ALL subsequent interaction with the present invention follows a post-authentication communication pathway [103-104-101], which effectively bypasses the authentication routine for the duration of the session. However, once a user or administrator terminates a session by logging off from the present invention, re-authentication is enforced [101-102-103].

The present invention is able to manage software & license assets that are meant to be resold or externally consumed, hereby referred to as Resell Licenses. Resell Licenses involve special processes, such as, but not limited to, quarterly royalty reporting, which are often tightly coupled to Sales pipelines, maintenance payments, and 3^{rd} party ISV OEM agreements. The present invention is able to integrate with other software parties [120] via web services [121] for specific processes involving Resell Licenses.

All available functions and processes in this embodiment of the present invention are tightly coupled to the master server properties file [140] and the multiple owner properties files [150]. The master server properties file maintains key parameters and settings, which directly affect the runtime of the present invention. Global properties contained in the master properties file are read at startup and during the normal operation of the present invention. Similarly, the multiple owner properties files each contains parameters and settings that are instantiated at startup and read during runtime, but unlike the master server properties file, the multiple owner properties files are personalized and specific to the individual users/owners. For example, company A may have very different startup and runtime requirements than company B, and the multiple owner properties files accommodate these scenarios. The present invention is able to accomplish such complex management of multiple owner assets because of the present invention's unique re-use of COMMON asset Meta Data maintained in its RDBMS coupled to the personalized and specific settings in the multiple owner properties files. This unique combination enables significant efficiencies of scale and asset re-use, while enforcing strict compliance base on utilization terms and conditions.

It will be understood that, in addition to software & license or physical/virtual machine assets, the present invention can also manage other physical and abstract assets with the same level of sophistication.

It is further intended that any other embodiments of the present invention that result from any changes in application or method of use or operation, method of development, shape, size, or material which are not specified within the detailed written description contained herein yet are considered apparent or obvious to one skilled in the field of software development and asset management, are within the scope of the present invention.

I claim:

1. A method of managing software and license assets using check-out and check-in, comprising:
providing a server system;
coupling the server system to a network;
coupling the networked server system to an authentication source;
coupling the networked server system to a web server;
coupling the networked server system to a backend RDBMS;
coupling the networked server system to a SMTP system for email delivery of checked-out software and license(s).

2. The method of claim 1, wherein the networked server system provides a web portal to a comprehensive search utility used to search the software and license assets for a desired entry, followed by a check-out feature.

3. The method of claim 1, wherein the server system is hosted on the Internet.

4. The method of claim 1, wherein the server system is hosted on an isolated corporate network.

5. The method of claim 3, wherein the server system manages the software and license assets of multiple owners.

6. The method of claim 1, wherein the server system email contains details of the checked-out software and/or corresponding license, such as, but not limited to, software name, # of license(s) checked-out, a URL link to online software, and a URL link to license key.

7. The method of claim 1, wherein the server system email contains details of the checked-in software and/or corresponding license, such as, but not limited to, software name, and # of license(s) checked-in.

8. The method of claim 6, wherein the server system administratively expires the email URL link to the online software and license after the end-user or administrator has reconciled the software and/or corresponding license back into the library via a check-in.

9. The method of claim 2, wherein a software check-out is not permitted because of pre-defined license terms, or lack of available licenses.

10. The method of claim 2, wherein a license reservation is not permitted because of pre-defined license terms, or lack of available licenses.

11. A method of managing physical and virtual machine assets using check-out and check-in, comprising:
providing a server system;
coupling the server system to a network;
coupling the networked server system to an authentication source;
coupling the networked server system to a web server;
coupling the networked server system to a VM (Virtual Machine) manager;
coupling the networked server system to a backend RDBMS;
coupling the networked server system to a SMTP system for email delivery of checked-out physical/virtual machines(s).

12. The method of claim 11, wherein the networked server system provides a web portal to a comprehensive search utility used to search the physical and virtual machine assets for a desired entry, followed by a check-out feature.

13. The method of claim 11, wherein the server system is hosted on the Internet.

14. The method of claim 11, wherein the server system is hosted on an isolated corporate network.

15. The method of claim 13, wherein the server system manages the physical and virtual machine assets of multiple owners.

16. The method of claim 11, wherein the server system email contains details of the checked-out physical or virtual machine, such as, but not limited to, device name, network address, a URL link to more granular details such as point of contact, project allocation, location, and logon credentials.

17. The method of claim 11, wherein the server system email contains details of the checked-in physical or virtual machine, such as machine name, time of check-in, point of contact, project de-allocation, and future availability.

18. The method of claim 16, wherein the server system administratively expires the email URL link to the granular details for the physical and virtual machine after the end-user or administrator has reconciled the physical or virtual machine back into the library via a check-in.

19. The method of claim 11, wherein a physical or virtual machine check-out is not permitted because of pre-defined terms, or lack of available resources.

20. The methods of claims 5 and 15, wherein each of multiple owners has its own properties file, yet shares common Meta Data in the back-end RDBMS.

21. The methods of claims 5, 15, and 20, wherein the online software and license(s) of multiple users are shared across the entire landscape of multiple users for storage efficiency, based on license compliance terms.

22. The methods of claims 1 and 11, wherein the web pages served up by the web server are accessed via a dedicated centralized library kiosk.

23. The methods of claims 1 and 11, wherein the server system provides a dynamic user-editable knowledge-base for all managed assets, which is accessible to all users, either single owners or multiple owners.

24. The methods of claims 1 and 11, wherein the server system provides a queuing utility, which enables users to add themselves to the next available check-out in the event that a managed asset has no current availability.

25. The method of claim 11 wherein the virtual machine assets are integrated into the library system for check-out and check-in.
